(19) United States
(12) Patent Application Publication
(10) Pub. No.: US 2009/0249935 A1
(43) Pub. Date: Oct. 8, 2009

(54) SLICER

(75) Inventor: Sascha Kaposi, Tacoma, WA (US)

Correspondence Address: BLACK LOWE & GRAHAM, PLLC, 701 FIFTH AVENUE, SUITE 4800, SEATTLE, WA, 98104, US

(73) Assignee: PROGRESSIVE INTERNATIONAL CORPORATION, Kent, WA (US)

(21) Appl. No.: 12/124,969

(22) Filed: May 21, 2008

Related U.S. Application Data
(63) Continuation-in-part of application No. 12/118,620, filed on May 9, 2008.
(60) Provisional application No. 61/042,648, filed on Apr. 4, 2008.

(51) Int. Cl. A47J 43/00; B26D 5/10

(52) U.S. Cl. 83/635; 241/94; 241/283; 83/570; 83/637

(57) ABSTRACT

A food slicer includes a lower container for holding sliced food items and one or more blades at the top. A pushing element is secured within a housing, with the housing being configured to slide vertically with respect to the container. A pair of pillars and a pair of guides form a path such that the pushing element follows a generally straight and vertical path as it moves downward toward the blades.

### PRIORITY CLAIM

This application is a continuation-in-part of U.S. utility application Ser. No. 12/118,620, filed May 9, 2008, which claims the benefit of prior U.S. provisional application Ser. No. 61/042,648, filed Apr. 4, 2008.

### FIELD OF THE INVENTION

This invention relates generally to food slicing devices, particularly including devices in which a food item is sliced by urging it through a grid of slicing blades.

### BACKGROUND OF THE INVENTION

There are a variety of slicing devices on the market in which a food item such as an onion is sliced by urging it through a tray or grid of slicing blades. In some examples of such devices, a pusher and slicing grid are pivotally movable with respect to one another and brought together to slice the item. In other examples, complicated levers, springs, or gears are involved and these components increase cost and complexity as well as make the device more difficult to clean.

### SUMMARY OF THE INVENTION

A preferred example of the invention includes a lower receptacle for holding chopped food items and one or more blades at a top of the receptacle. In one form, the receptacle is an open-topped container configured to hold a grid of blades spanning the open top. A pushing element is secured within an outer housing, with the outer housing being configured to snugly and slideably fit around the receptacle. The housing therefore forms a guide path to keep the path of the pushing element in a generally straight and vertical orientation as it moves axially downward toward the blades.

In some versions of the invention, the grid of blades is removable and can be replaced by one or more different configurations, such as straight, pyramidal, V-shaped, or other blade types.

In some examples of the invention the pushing element is also removable and can be replaced by one or more different configurations that mate closely with corresponding replacement blade configurations.

These and other examples of the invention will be described in further detail below.

### BRIEF DESCRIPTION OF THE DRAWINGS

Preferred and alternative examples of the present invention are described in detail below with reference to the following drawings:

FIG. 1 is a perspective view of a preferred device;

FIG. 2 is an exploded view of a preferred device;

FIG. 3 is an exploded view of an alternate form of a preferred device;

FIG. 4 is an exploded view of an alternate form of a preferred device;

FIG. 5 is perspective cutaway view of a housing in accordance with a preferred device;

FIG. 6 is a perspective view of a preferred pusher element;

FIG. 7 is a perspective view of an alternate pusher element;

FIG. 8 is a perspective view of an alternate example of the invention; and

FIG. 9 is an exploded view of the alternate example shown in FIG. 8.

### DETAILED DESCRIPTION OF THE PREFERRED EMBODIMENT

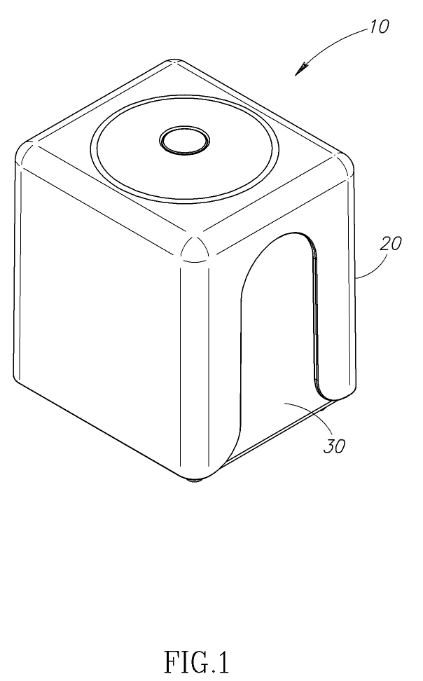

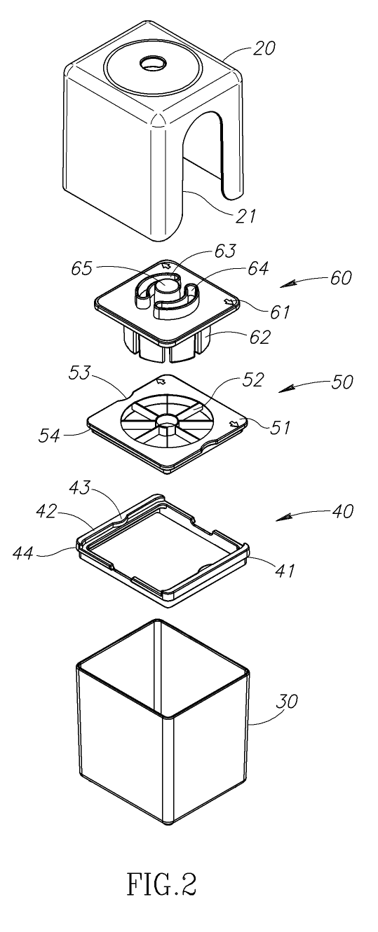

FIG. 1 shows a perspective view of a preferred slicing device 10. As shown, an outer pusher housing 20 surrounds a container 30. In this example of the invention, the container 30 is generally of a rectangular cubic shape, having a base, upwardly extending sidewalls, and an open top (best seen in FIG. 2). The pusher housing 20 is of a mating, complementary shape in that an interior surface of the housing snugly receives an exterior surface of the container so that the housing is able to slide up and down about the container. As shown, the interior of the sidewalls of the housing abut the majority of the exterior of the container and forms a close fit, thereby frictionally engaging the container as the housing slides up and down. In this version the housing and container are not permanently fastened to one another, but rather can be freely separated if the housing is pulled upward from the container a sufficient distance.

In other versions of the invention, other shapes for the housing and container are used. For example, the housing and container may each have a substantially cylindrical shape, formed in a similar mating fashion as discussed above. In other versions the housing need not have an interior surface that substantially abuts the entire exterior surface of the container. Rather, a track or other guide may form the respective surfaces to ensure that the housing follows a path of travel that is generally aligned with an axis extending upward through the center of the container.

In some versions of the invention an upper surface of the housing 20 is bulged upward to accommodate the palm of a user when pushing the housing downward. In other versions the upper surface is flat.

FIG. 2 provides an exploded view of the preferred example of the invention. The container 30 as shown is an open-topped rectangular cubic vessel. Preferably the container is formed from a clear plastic, though other materials may be used.

A frame 40 includes a perimeter that is substantially the same as that of the rim of the open top of the container 30, thereby allowing the frame to be snugly received within the open top of the container. The frame includes a downwardly extending leg and outwardly extending flange forming a shoulder 41 that allows the frame to properly seat on the rim without falling farther into the container. The frame 40 and container 30 are preferably sized and configured such that the frame is frictionally retained within the container. In other versions the frame may be glued or otherwise affixed to the container. Alternatively, the attributes of the frame may be integrally formed with the container.

The frame 40 further includes an upwardly extending peripheral flange 42. In some versions the flange 42 may extend substantially around the perimeter of the frame. In the example shown, however, the flange 42 is formed as a pair of opposing sidewall sections on opposite sides of the frame. On each end of each of the opposing sidewall sections, a lip 44 juts outward toward the opposing sidewall. The sidewall sections extend upward from a horizontal lower portion of the frame to provide a seat that is configured to receive a blade tray 50, discussed further below.

A portion of the frame 40 optionally includes one or more wells 46. As shown, a well is provided on each of the frame sections extending between the opposing upwardly extending sidewalls. The wells facilitate the removal of the blade tray 50 by providing a region in which there is no frame material abutting the blade tray.

An alignment tab 43 is integrally formed in one or both of the upwardly extending flanges 42. As shown, the alignment tab is crescent-shaped and extends from a center portion of the sidewall toward the interior of the frame. A matching alignment tab is formed on the opposite sidewall. In other versions of the invention, the alignment tab can be formed in different shapes and in different locations on the frame.

The blade tray 50 as shown includes an outer perimeter that is sized to fit within the seat defined on the frame. Thus, in the preferred example the blade tray is substantially square in its outer perimeter. The perimeter of the blade tray 50 includes a peripheral flange forming a shoulder 54 that is complementary to the seat defined in the frame so that the blade tray forms a relatively tight frictional fit within the frame.

A recessed region 53 is provided at a peripheral location on the blade tray 50 that is sized and shaped to match that of the tab 43, thereby ensuring that the blade tray is inserted in the proper orientation. Depending on the location of the tab and recessed regions, the blade tray may be configured so that it may only be inserted in a single orientation or, alternatively, in more than one orientation.

The blade tray further includes an open central area having one or more blades 52. As discussed in greater detail below, the blade tray preferably is removable from the frame, thereby allowing the blade tray to be replaced with a different blade tray having a different blade configuration.

An upper surface of the blade tray includes an alignment indicator, which in the example shown is in the form of a pair of arrows 51. The alignment indicator provides a visual indication of the orientation of the blade tray so that a pusher 60 can be readily aligned in the same orientation in the event the orientation is important between the particular blade tray and pusher being used.

The pusher 60 includes one or more downwardly extending projections 62 that are sized and configured to pass between the blades within the blade tray. In the preferred example of the invention, the pusher 60 is removably attached to an upper interior surface of the housing 20. The pusher may be snap-fit, friction-fit, or otherwise attached to the housing in any manner that allows it to be removably retained within the housing. While the pusher is best configured for removable attachment, in some versions of the invention the pusher is either permanently affixed to the housing or is integrally formed within the housing itself.

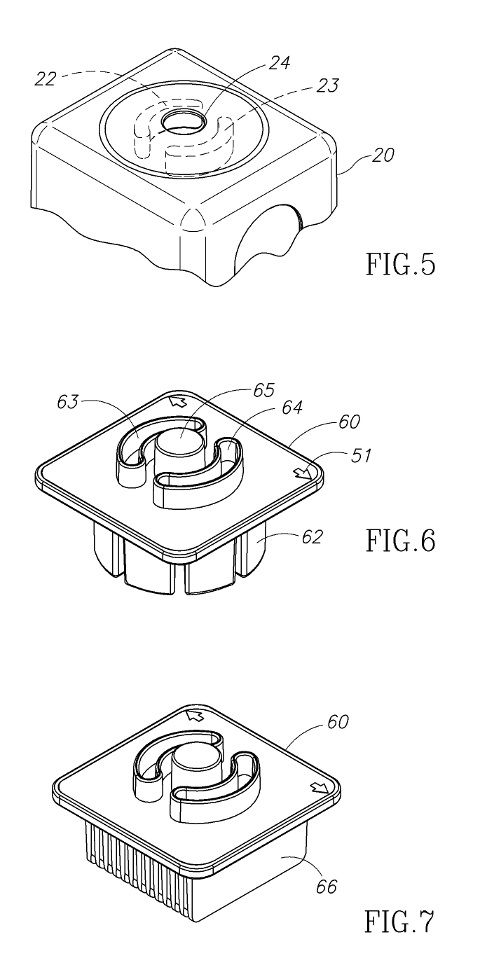

In the configuration as shown, the pusher includes a central pillar 65 extending upward in a direction opposite that of the pusher projections 62, as best seen in FIG. 6. The pillar is surrounded by two supports 63, 64 defining crescent-shaped channels. The interior surface of the housing includes mating structures to retain and secure the pusher within the housing, as best seen in FIG. 5. Thus, a pair of crescent-shaped stems or projections 22, 23 are provided within the housing, extending downward from the upper interior surface, the stems being configured to be received within the channels within the arc-shaped supports 63, 64. Likewise, a cylindrical well 24 is configured in the upper interior surface of the housing to receive the pillar 65. The well may be formed as a circular flange extending downward from the housing, or may alternatively be formed as a bore entirely through the top surface of the housing. In the version incorporating a bore, a portion of the pillar preferably extends through the bore and allows the user to press directly against the pillar of the pusher. In other versions of the invention, a wide variety of other structures are possible to provide snap-fit, frictional, or other engagement between the pusher 60 and the housing 20.

In one example of the invention, the housing 20 is formed from a clear plastic material, allowing the pusher to be visible through the housing. In addition, the clear material makes the alignment arrows 61 visible, helping to ensure that the housing is oriented properly with the alignment arrows 61 of the pusher 60 oriented in the same fashion as the alignment arrows 51 of the blade tray 50.

The housing may optionally include an opening 21 on one or more of its sidewalls. In the example as shown, the opening 21 is a high arch extending along the majority of the length of one of the housing sidewalls. A similar opening is also provided on the opposite sidewall in the preferred version of the invention. In other examples of the invention, an opening may be provided on all four sidewalls or, conversely, no openings may be provided at all. The inclusion of two opposing openings allows the user to have access to the interior of the slicer to adjust a food item with the housing in place, but retains structural rigidity of the housing to ensure proper alignment during use.

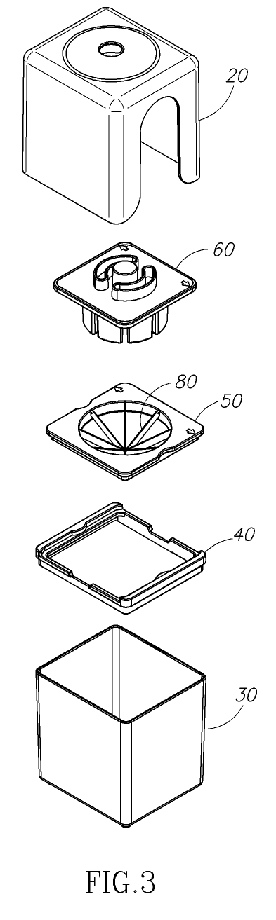

FIG. 3 provides a similar exploded view as in FIG. 2, but with a different blade tray 50. The preferred blade trays are discussed further below.

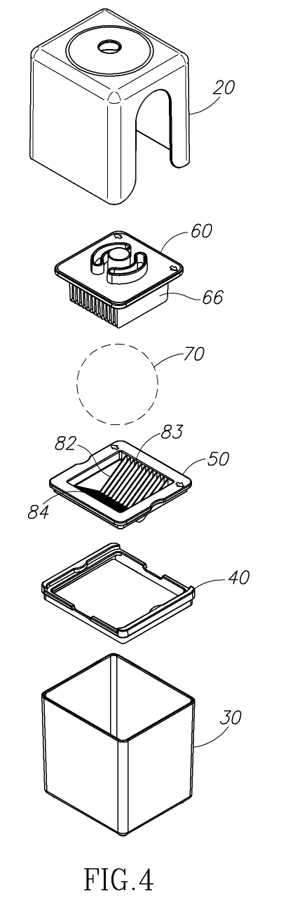

As shown in FIG. 4, the chopper and slicer as described is configured to chop or slice an object such as a food item such as an onion, an apple, or any other item that is desired to be chopped or sliced. Thus, the food item 70 is placed atop the blade tray 50 when it is seated in the frame 50 atop the container 30. The housing 20, having a pusher 60 secured within it, is placed around the container such that the projections of the pusher abut the food item 70. Generally at that point the sidewalls of the container and those of the housing will be frictionally engaged with one another. Pressure is applied to the top of the housing, urging it downward toward the container. The downward pressure likewise pushes the pusher against the food item, forcing it through the blade tray so that the food item is sliced by the blades within the tray. The projections of the pusher are configured to extend through the lower edges of the blades, thereby forcing the food item thoroughly through the blades. The close fit of the housing and the container allow for a smooth and straight path of travel of the pusher toward and through the blades.

The general path of travel of the housing with respect to the container is vertical. Thus, the container defines a central axis that is substantially at the center of the container sidewalls. In the case of a container having straight sidewalls, the central axis is parallel to the sidewalls. The container may be irregular or have angled sides, and in such cases the central axis is preferably in the middle of the sidewalls and extends vertically, orthogonal to the base of the container and substantially at the center of the base of the container. The housing follows a path of travel that is substantially along the central axis, unlike a hinged chopping device.

Because the blade trays and pushers are both removable, they may be replaced with other blade trays and pushers of different configurations. In the version as illustrated in FIG. 2, for example, the blade tray is configured as a corer and slicer. Thus, the blade tray includes a central circular slicing hub blade and eight radially-extending blades 52, each of which is substantially straight. Each of the blades is preferably formed from stainless steel. The mating pusher 60 includes projections 62 such that an individual projection is sized and configured to fit between the openings defined by each of the eight wedges and the central hub. While the corer and slicer blade tray as shown is configured to produce eight slices, alternative versions may have, for example, four or six blades to produce four or six wedge-shaped slices. The pusher for such variations will likewise have a different number of projections sized to mate with the corresponding tray.

In the version of FIG. 3, the blade tray 50 includes a circular blade opening and eight radially projecting blades 80 joined at a first end at the center of the opening and at a second end to the perimeter of the opening. As shown, the blades are angled downward from the perimeter to the center, forming a cone-shaped grid of blades defining eight wedge-shaped openings between the blades. The corresponding pusher 60 (best seen in FIG. 6) likewise has eight projections sided and configured to fit between corresponding openings. In other versions, a conical blade tray may include a different number of blades, for example four or six, and the pusher includes a corresponding number of mating projections.

The blade tray as depicted in FIG. 4 includes a plurality of V-shaped blades 82, each of which includes a first end 83 secured to one side of the blade tray and a second end 84 secured to an opposite side of the tray. The blades are angled downward from each end toward a point generally at the center of the blade, forming a V shape. A top surface of each of the blades is preferably sharpened to facilitate the slicing. Any number of V-shaped blades are provided in the blade tray, longitudinally aligned and spaced to provide slices of a desired width.

The pusher 60 corresponding to the V-shaped blade is best seen in FIG. 7 and preferably has a plurality of straight, flange-shaped pusher projections 66 sized and configured to fit between the spaces between V-blades. In the preferred form, the projections 66 are generally rectangular in shape, as viewed from the side.

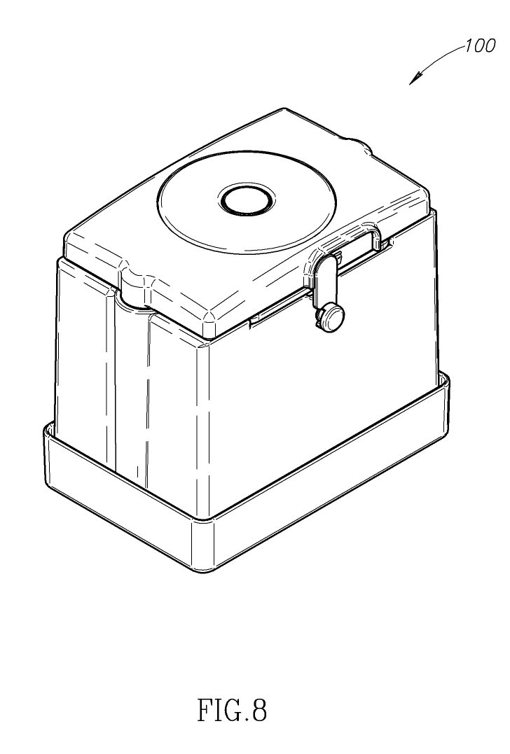

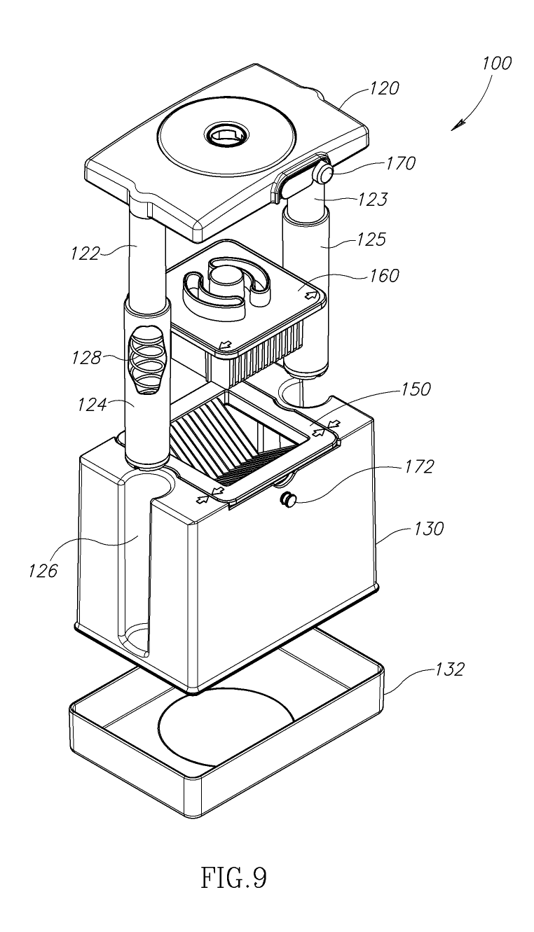

An alternate example of a slicer device 100 is shown in a perspective view in FIG. 8 and an exploded view in FIG. 9. In this version, the device includes a main container 130 with a removable base tray 132. The tray 132 is preferably either snap-fit or friction-fitted to the container 130.

An upper surface of the container 130 supports a blade tray 150. The blade tray in this alternate version is generally the same as in the prior version discussed above and includes a plurality of blades configured to slice or chop a food item into pieces. Though not shown, the blade tray 150 may be secured to the top of the container 130 using the shoulder and seat arrangement as discussed above or in any other manner that enables the blade tray to be firmly secured to the container. The blade tray 150 is further removably secured to the container 130 to allow the blade tray 150 to be replaced with other blade trays having blades of different configurations. Alignment arrows or other indicators are optionally provided to ensure that the blade tray is inserted in the correct orientation.

A pusher 160 includes downwardly extending projections that are sized and configured to pass between the blades of the blade tray 150, in the same manner as discussed with respect to the examples above. The pusher may be snap-fit, friction-fit, or otherwise secured to a pusher housing 120. Preferably the pusher is removably secured to the housing so that it can be removed and replaced with a pusher having a different configuration to mate with alternate blade trays as desired. Though not shown, in a preferred form the pusher housing includes structures to secure the pusher to the housing in the same manner as discussed with other embodiments discussed above.

In this alternate configuration, the pusher housing 120 differs from the housing 20 of the prior configuration in that it is arranged as a lid rather than an outer box. The housing 120 is secured to a pair of pillars 122, 123 that are each received within mating guides 124, 125. As shown, the pillars and guides are substantially cylindrical in cross-sectional shape, but they may alternatively be square, oval, or have other shapes. In use, the pillars are slideably received within the guides to allow the housing 120 to slide up and down with respect to the container 130, thereby allowing the pusher 160 to be pressed downward against the blade tray 150 and removed vertically away from the blade tray. The close frictional fit of the pillars within the guides ensures a close alignment of the pusher projections within the blade tray. In the preferred form as illustrated the pillars are received within the guides. Alternatively, the device may be formed such that the guides are slideably received within the pillars.

In the version as shown, the guides 124, 125 are formed separately from the container 130 and are secured to the container within channels formed in the sides of the container. In FIG. 8 a first channel 126 is visible but the opposite channel is not visible. The guides may be friction-fit, snap-fit, threadably secured, glued, or otherwise secured within the channels. In other examples of the invention, the guides are integrally formed within the container and directly receive the pillars. In the version as shown, a single pillar is used. In other versions, multiple telescoping pillars may be used.

Preferably, a coil spring is provided inside each of the guides 124, 125 with one end of the spring 128 (shown in partial cut-away) engaging a lower surface of the guide and the opposite end engaging a lower surface of the pillar. In this fashion, the springs urge the pillars upward, pushing the pusher housing 120 away from the container 130 and blade tray 150.

For storage, a hook 170 on a pivoting arm and a peg 172 are provided. The hook 170 is pivotally mounted on a surface of the pusher housing and configured so that it can pivot downward toward the container. The peg 172 is provided on an outer surface of the container and positioned so that the hook engages the peg when pivoted downward. The hook thereby holds the pusher housing against the container despite the upward force of the springs, covering the blade tray for more compact storage as seen in FIG. 8. In order to use the device, the hook 170 is rotated upward where an inner surface of the arm engages a detent that holds the arm in an upward position as seen in FIG. 9.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A slicing device, comprising:
a container having a base, an upper surface and a plurality of sidewalls defining an interior space, and the container further having a channel incorporated into at least one of the sidewalls;
a blade tray spanning an opening in the upper surface of the container, the blade tray having a plurality of blades defining a plurality of blade openings;
a pusher having one or more projections configured to be received within at least one of the plurality of blade openings;
a hollow guide sized to be closely received by the channel of the container, the guide having an inner surface configured to support a biasing member located within the guide; and
a pusher housing having a centered engagement interface for selectable alignment with a complementary engagement interface of the pusher, the pusher housing further having an elongated pillar telescopica1ly receivable by the guide, the pillar having a first end portion coupled to the pusher housing and a second end potion in contact with the biasing member, wherein the pusher housing is slideably movable with respect to the container in a direction substantially along a longitudinal axis of the pillar.

2. The slicing device of claim 1, wherein the hollow guide is a hollow cylinder.

3. The slicing device of claim 2, wherein the blade tray is removably secured to the container.

4. The slicing device of claim 1, wherein the engagement interface of the pusher and the complementary engagement interface of the pusher housing both include pairs of crescent-shaped protuberances respective1y engagable with each other.

5. The slicing device of claim 2, wherein the pusher is integrally formed within the pusher housing.

6. The slicing device of claim 1, wherein the biasing device includes a compression spring.

7. The slicing device of claim 4, further comprising a cylindrical extension located between at least one pair of the crescent-shaped protuberaces.

8. The slicing device of claim 6, further comprising a hook secured to the pusher housing and a peg secured to the container, whereby the hook is engageable to the peg to secure the pusher housing to the upper surface of the container.

9. The slicing device of claim 6, further comprising a pair of channels formed in the sidewalls of the container, each one of the pair of guides being secured to a respective one of the channels.

10. The slicing device of claim 6, wherein the pusher housing further comprises at least one projection extending downward and the pusher comprises at least one channel, the projection being sized and configured to be received within the channel to secure the pusher to the pusher housing.

11. The slicing device of claim 10 wherein the projection is crescent shaped.

12. The slicing device of claim 6, wherein the pusher further includes an alignment marking.

13. The slicing device of claim 12, wherein the pusher housing is formed from a clear material, whereby the alignment marking is visible through the pusher housing.

14. The slicing device of claim 6, wherein the base of the container is removably secured to the sidewalls.

15. A slicing device, comprising:
a container having a base, an upper surface and a plurality of sidewalls defining an interior space, and the container further having a channel recessed into at least one of the sidewalls;
a blade tray spanning an opening in the upper surface of the container, the blade tray having a plurality of blades defining a plurality of blade openings;
a pusher having a plurality of pusher projections arranged to mate with the plurality of blade openings; and
a pusher housing having alignment members configured to complementarily and selectively engage the pusher, the pusher housing further having a telescoping guide assembly closely receivable by the channel of the container, the telescoping guide assembly having a biasing member configured to urge the pusher housing away from the container, wherein the pusher housing is slideably movable with respect to the container in a direction substantially along a longitudinal axis of the telescoping guide assembly.

16. The slicing device of claim 15, wherein the channel includes an open side facing away from the blade tray.

17. The slicing device of claim 15, wherein the telescoping guide assembly includes a cavity configured to receive the biasing member.

18. The slicing device of claim 15, wherein the telescoping guide assembly includes pillars received by hollow guides, and wherein the pillars are configured to have a frictional fit within the guides to provide a close alignment of the pusher projections within the blade openings.
